(19) United States
(12) Patent Application Publication
(10) Pub. No.: US 2025/0071508 A1
(43) Pub. Date: Feb. 27, 2025

(54) INTELLIGENT PROXIMITY SYSTEM

(71) Applicant: Samsung Electronics Co., Ltd., Suwon-si (KR)

(72) Inventors: Daoud Burghal, San Jose, CA (US); Hao Chen, Allen, TX (US); Han Wang, Allen, TX (US); Samuel Albert, Robbinsville, NJ (US); Xiaochuan Ma, Hillsborough, NJ (US); Yan Xin, Princeton, NJ (US); Russell Ford, San Jose, CA (US); Yong Ren, Somerset, NJ (US)

(21) Appl. No.: 18/614,620

(22) Filed: Mar. 22, 2024

Related U.S. Application Data
(60) Provisional application No. 63/533,879, filed on Aug. 21, 2023.

(51) Int. Cl. H04W 4/021

(52) U.S. Cl. CPC H04W 4/021

(57) ABSTRACT

An electronic device includes a transceiver configured to receive information related to an action request or rule. The electronic device further includes a processor operatively coupled to the transceiver. The processor is configured to determine that the action is location based, and identify a zone within which the electronic device is located. The identification of the zone is based on at least one of a first reception by the transceiver of at least one signal indicative of a location of the electronic device, and a second reception by the transceiver of at least one response to a transmission of a signal indicative of a location of the electronic device. The processor is further configured to trigger an action based on the action request or rule and the identified zone.

### CROSS-REFERENCE TO RELATED APPLICATION AND CLAIM OF PRIORITY

This application claims priority under 35 U.S.C. § 119(e) to U.S. Provisional Patent Application No. 63/533,879 filed on Aug. 21, 2023. The above-identified provisional patent application is hereby incorporated by reference in its entirety.

### TECHNICAL FIELD

This disclosure relates generally to electronic devices. More specifically, this disclosure relates to methods and apparatuses for intelligent proximity systems.

### BACKGROUND

User location information (or proximity) is a key enabler for location-based services (LBS). Applications span numerous emerging services for smart environments, e.g., homes, offices, shops, and hospitals. Examples include home automation, optimized energy consumption, personal assistance, and health care. While location information can be identified with satisfactory accuracy in many outdoor environments, indoor user proximity has proven to be very challenging. Recently, thanks to the proliferation of mobile phones, wearable, and IoT devices, not only have new applications emerged, but also new localization solutions suited for intelligent environments can be implemented.

### SUMMARY

This disclosure provides methods and apparatuses for intelligent proximity systems.

In one embodiment, an electronic device is provided. The electronic device includes a transceiver configured to receive information related to an action request or rule. The electronic device further includes a processor operatively coupled to the transceiver. The processor is configured to determine that the action is location based, and identify a zone within which the electronic device is located. The identification of the zone is based on at least one of a first reception by the transceiver of at least one signal indicative of a location of the electronic device, and a second reception by the transceiver of at least one response to a transmission of a signal indicative of a location of the electronic device. The processor is further configured to trigger an action based on the action request or rule and the identified zone.

In another embodiment, a method of operating an electronic device is provided. The method includes receiving information related to an action request or rule, determining that the action is location based, and identifying a zone within which the electronic device is located. The identification of the zone is based on at least one of a first reception of at least one signal indicative of a location of the electronic device, and a second reception of at least one response to a transmission of a signal indicative of a location of the electronic device. The method further comprises triggering an action based on the action request or rule and the identified zone.

In yet another embodiment, a non-transitory computer readable medium embodying a computer program is provided. The computer program includes program code that, when executed by a processor of a device, causes the device to receive information related to an action request or rule, determine that the action is location based, and identify a zone within which the device is located. The identification of the zone is based on at least one of a first reception of at least one signal indicative of a location of the device, and a second reception of at least one response to a transmission of a signal indicative of a location of the device. The computer program further includes program code that, when executed by a processor of a device, causes the device to trigger an action based on the action request or rule and the identified zone.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example communication system according to embodiments of the present disclosure;

FIG. 2 illustrates an example electronic device according to embodiments of the present disclosure;

FIG. 3 illustrates a process 300 for an intelligent proximity system according to embodiments of the present disclosure;

FIG. 4 illustrates an example 400 of interactions in an intelligent proximity system according to embodiments of the present disclosure;

FIG. 5 illustrates an example 500 of overall operation of an intelligent proximity system according to embodiments of the present disclosure;

FIG. 6 illustrates a method 600 of operating an intelligent proximity system according to embodiments of the present disclosure;

FIG. 7 illustrates an example of using ultrasound for zone identification according to embodiments of the present disclosure;

FIG. 8 illustrates a method of using Line of Sight in wireless communication to identify zones according to embodiments of the present disclosure;

FIG. 9 illustrates a method of action triggering according to embodiments of the present disclosure;

FIG. 10 illustrates a method for action rules and list construction according to embodiments of the present disclosure;

FIG. 11 illustrates a method for updating an inference model according to embodiments of the present disclosure; and

FIG. 12 illustrates a method for operating an intelligent proximity system according to embodiments of the present disclosure.

### DETAILED DESCRIPTION

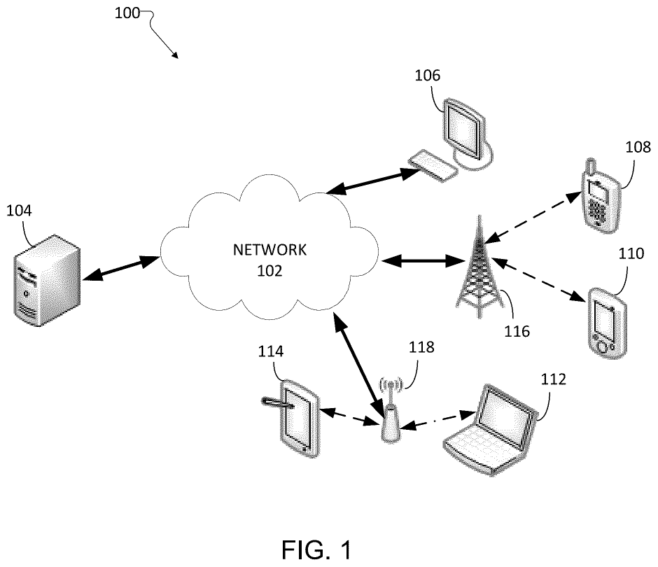

FIGS. 1 through 12, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

The present disclosure covers several components which can be used in conjunction or in combination with one another or can operate as standalone schemes. Certain embodiments of the disclosure may be derived by utilizing a combination of several of the embodiments listed below. Also, it should be noted that further embodiments may be derived by utilizing a particular subset of operational steps as disclosed in each of these embodiments. This disclosure should be understood to cover all such embodiments.

FIG. 1 illustrates an example communication system 100 according to embodiments of the present disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-114. The client devices 106-114 may be, for example, a smartphone (such as a UE), a tablet computer, a laptop, a personal computer, a wearable device, a head mounted display, or the like. The server 104 can represent one or more servers. Each server 104 includes any suitable computing or processing device that can provide computing services for one or more client devices, such as the client devices 106-114. Each server 104 could, for example, include one or more processing devices, one or more memories storing instructions and data, and one or more network interfaces facilitating communication over the network 102.

Each of the client devices 106-114 represent any suitable computing or processing device that interacts with at least one server (such as the server 104) or other computing device(s) over the network 102. The client devices 106-114 include a desktop computer 106, a mobile telephone or mobile device 108 (such as a smartphone), a PDA 110, a laptop computer 112, and a tablet computer 114. However, any other or additional client devices could be used in the communication system 100, such as wearable devices. Smartphones represent a class of mobile devices 108 that are handheld devices with mobile operating systems and integrated mobile broadband cellular network connections for voice, short message service (SMS), and Internet data communications. In certain embodiments, any of the client devices 106-114 can perform processes for determining UWB beacon locations for service areas for a location based service.

In this example, some client devices 108-114 communicate indirectly with the network 102. For example, the mobile device 108 and PDA 110 communicate via one or more base stations 116, such as cellular base stations or eNodeBs (eNBs) or gNodeBs (gNBs). Also, the laptop computer 112 and the tablet computer 114 communicate via one or more wireless access points 118, such as IEEE 802.11 wireless access points (APs). Note that these are for illustration only and that each of the client devices 106-114 could communicate directly with the network 102 or indirectly with the network 102 via any suitable intermediate device(s) or network(s). In certain embodiments, any of the client devices 106-114 transmit information securely and efficiently to another device, such as, for example, the server 104.

As described in more detail below, one or more of the network 102, server 104, and client devices 106-114 include circuitry, programing, or a combination thereof, to support methods for intelligent proximity systems.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

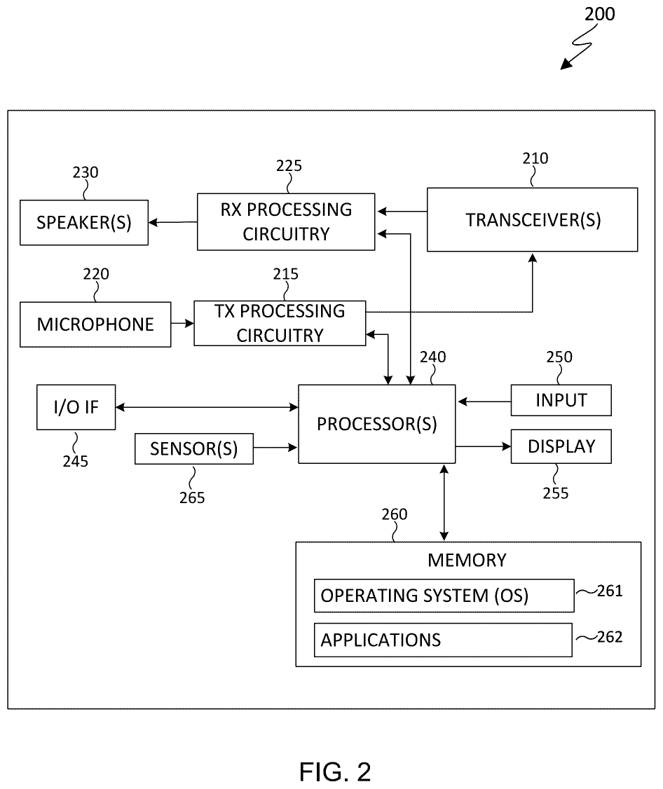

FIG. 2 illustrates an example electronic device according to embodiments of the present disclosure. In particular, FIG. 2 illustrates an example electronic device 200, and the electronic device 200 could represent the server 104 or one or more of the client devices 106-114 in FIG. 1. The electronic device 200 can be a mobile communication device, such as, for example, a UE, a mobile station, a subscriber station, a wireless terminal, a desktop computer (similar to the desktop computer 106 of FIG. 1), a portable electronic device (similar to the mobile device 108, the PDA 110, the laptop computer 112, or the tablet computer 114 of FIG. 1), a wearable device, and the like.

As shown in FIG. 2, the electronic device 200 includes transceiver(s) 210, transmit (TX) processing circuitry 215, a microphone 220, and receive (RX) processing circuitry 225. The transceiver(s) 210 can include, for example, a RF transceiver, a BLUETOOTH transceiver, a WiFi transceiver, a ZIGBEE transceiver, an infrared transceiver, an ultrasound transceiver, and various other wireless communication signals. The electronic device 200 also includes a speaker 230, a processor 240, an input/output (I/O) interface (IF) 245, an input 250, a display 255, a memory 260, and a sensor 265. The memory 260 includes an operating system (OS) 261, and one or more applications 262.

The transceiver(s) 210 can include an antenna array including numerous antennas. For example, the transceiver(s) 210 can be equipped with multiple antenna elements. There can also be one or more antenna modules fitted on the terminal where each module can have one or more antenna elements. The antennas of the antenna array can include a radiating element composed of a conductive material or a conductive pattern formed in or on a substrate. The transceiver(s) 210 transmit and receive a signal or power to or from the electronic device 200. The transceiver(s) 210 receives an incoming signal transmitted from an access point (such as a base station, WiFi router, or BLUETOOTH device) or other device of the network 102 (such as a WiFi, BLUETOOTH, cellular, 5G, LTE, LTE-A, WiMAX, or any other type of wireless network). The transceiver(s) 210 down-converts the incoming RF signal to generate an intermediate frequency or baseband signal. The intermediate frequency or baseband signal is sent to the RX processing circuitry 225 that generates a processed baseband signal by filtering, decoding, and/or digitizing the baseband or intermediate frequency signal. The RX processing circuitry 225 transmits the processed baseband signal to the speaker 230 (such as for voice data) or to the processor 240 for further processing (such as for web browsing data).

The TX processing circuitry 215 receives analog or digital voice data from the microphone 220 or other outgoing baseband data from the processor 240. The outgoing baseband data can include web data, e-mail, or interactive video game data. The TX processing circuitry 215 encodes, multiplexes, and/or digitizes the outgoing baseband data to generate a processed baseband or intermediate frequency signal. The transceiver(s) 210 receives the outgoing processed baseband or intermediate frequency signal from the TX processing circuitry 215 and up-converts the baseband or intermediate frequency signal to a signal that is transmitted.

The processor 240 can include one or more processors or other processing devices. The processor 240 can execute instructions that are stored in the memory 260, such as the OS 261 in order to control the overall operation of the electronic device 200. For example, the processor 240 could control the reception of forward channel signals and the transmission of reverse channel signals by the transceiver(s) 210, the RX processing circuitry 225, and the TX processing circuitry 215 in accordance with well-known principles. The processor 240 can include any suitable number(s) and type(s) of processors or other devices in any suitable arrangement. For example, in certain embodiments, the processor 240 includes at least one microprocessor or microcontroller. Example types of processor 240 include microprocessors, microcontrollers, digital signal processors, field programmable gate arrays, application specific integrated circuits, and discrete circuitry. In certain embodiments, the processor 240 can include a neural network.

The processor 240 is also capable of executing other processes and programs resident in the memory 260, such as operations that receive and store data, and for example, processes that support methods for intelligent proximity systems. The processor 240 can move data into or out of the memory 260 as required by an executing process. In certain embodiments, the processor 240 is configured to execute the one or more applications 262 based on the OS 261 or in response to signals received from external source(s) or an operator. For example, applications 262 can include a multimedia player (such as a music player or a video player), a phone calling application, a virtual personal assistant, and the like.

The processor 240 is also coupled to the I/O interface 245 that provides the electronic device 200 with the ability to connect to other devices, such as client devices 106-114. The I/O interface 245 is the communication path between these accessories and the processor 240.

The processor 240 is also coupled to the input 250 and the display 255. The operator of the electronic device 200 can use the input 250 to enter data or inputs into the electronic device 200. The input 250 can be a keyboard, touchscreen, mouse, track ball, voice input, or other device capable of acting as a user interface to allow a user to interact with the electronic device 200. For example, the input 250 can include voice recognition processing, thereby allowing a user to input a voice command. In another example, the input 250 can include a touch panel, a (digital) pen sensor, a key, or an ultrasonic/ultrasound input device. The touch panel can recognize, for example, a touch input in at least one scheme, such as a capacitive scheme, a pressure sensitive scheme, an infrared scheme, or an ultrasonic/ultrasound scheme. The input 250 can be associated with the sensor(s) 265, a camera, and the like, which provide additional inputs to the processor 240. The input 250 can also include a control circuit. In the capacitive scheme, the input 250 can recognize touch or proximity.

The display 255 can be a liquid crystal display (LCD), light-emitting diode (LED) display, organic LED (OLED), active matrix OLED (AMOLED), or other display capable of rendering text and/or graphics, such as from websites, videos, games, images, and the like. The display 255 can be a singular display screen or multiple display screens capable of creating a stereoscopic display. In certain embodiments, the display 255 is a heads-up display (HUD).

The memory 260 is coupled to the processor 240. Part of the memory 260 could include a RAM, and another part of the memory 260 could include a Flash memory or other ROM. The memory 260 can include persistent storage (not shown) that represents any structure(s) capable of storing and facilitating retrieval of information (such as data, program code, and/or other suitable information). The memory 260 can contain one or more components or devices supporting longer-term storage of data, such as a read only memory, hard drive, Flash memory, or optical disc.

The electronic device 200 further includes one or more sensors 265 that can meter a physical quantity or detect an activation state of the electronic device 200 and convert metered or detected information into an electrical signal. For example, the sensor 265 can include one or more buttons for touch input, a camera, a gesture sensor, optical sensors, cameras, one or more inertial measurement units (IMUs), such as a gyroscope or gyro sensor, and an accelerometer. The sensor 265 can also include an air pressure sensor, a magnetic sensor or magnetometer, a grip sensor, a proximity sensor, an ambient light sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 265 can further include control circuits for controlling any of the sensors included therein. Any of these sensor(s) 265 may be located within the electronic device 200 or within a secondary device operably connected to the electronic device 200.

Although FIG. 2 illustrates one example of electronic device 200, various changes can be made to FIG. 2. For example, various components in FIG. 2 can be combined, further subdivided, or omitted and additional components can be added according to particular needs. As a particular example, the processor 240 can be divided into multiple processors, such as one or more central processing units (CPUs), one or more graphics processing units (GPUs), one or more neural networks, and the like. Also, while FIG. 2 illustrates the electronic device 200 configured as a mobile telephone, tablet, or smartphone, the electronic device 200 can be configured to operate as other types of mobile or stationary devices.

Location information is key to enabling many emerging applications in intelligent environments. While location information can be acquired with adequate accuracy in outdoor environments through a global navigation satellite system (GNSS) when line of sight (LOS) to GNSS satellites are present, localization in indoor or dense urban environments is very challenging due to (i) the typical harsh Non-LOS (NLOS) wireless signal, (ii) the possible need for additional infrastructure, and (iii) complexity constraints. Although there have been many efforts to tackle the location in these environments, existing localization solutions are not well suited to emerging applications for intelligent environments. In particular, existing localization solutions require dedicated infrastructure. For instance, solutions could use cameras, motion sensors, Bluetooth beacons, and ultrawideband receivers for location identification, which are contingent on the presence of suitable infrastructure. Furthermore, existing localization solutions have been designed independently of the intelligent environment and/or application. For instance, this is the case for many solutions for wireless local area network (WLAN) based indoor localization systems. These systems do not take full advantage of the smart environment and/or may not be suited for certain smart applications, which need to adapt to the usage pattern and environment evolution.

In an intelligent environment, desirable properties of proximity solution include:
Low complexity and fast deployment capability
Engagement with the surrounding infrastructure and environment
Adaptability and performance enhancement over time
Low burden to the user

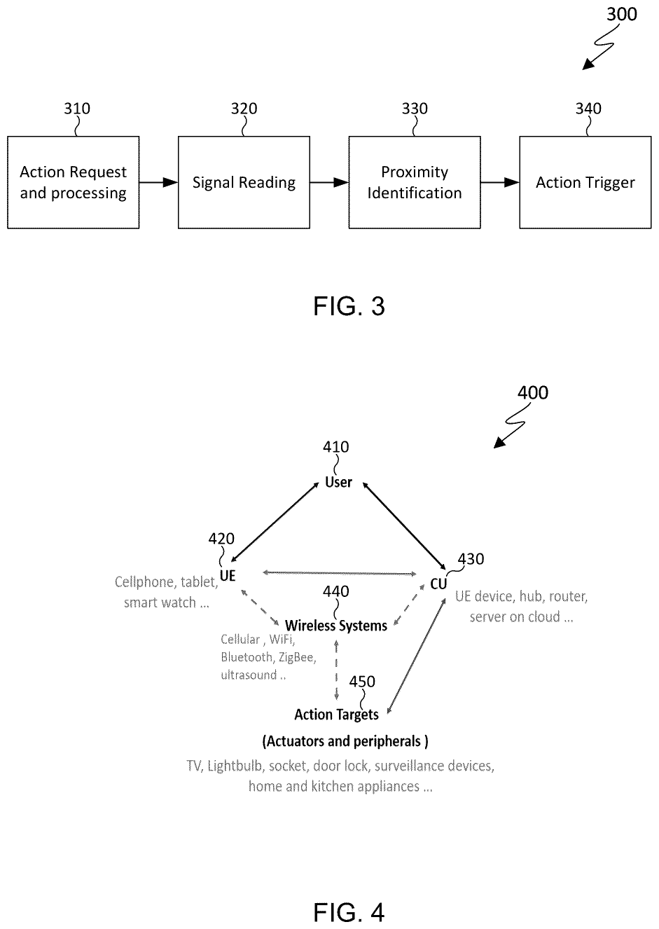

The present disclosure describes methods and apparatuses leveraging various smart devices to implement proximity systems that can enable smart automation. Additionally, the present disclosure describes methods and apparatuses for taking certain actions to improve the user's experience and enhance LBSs via the detection and monitoring of the user engagement with the environment. Furthermore, methods and apparatus are described for proximity detection in a smart environment to enable actions based on a user's request. The proximity system is referred to herein as an “intelligent proximity system.” A high level process for an example intelligent proximity system is shown in FIG. 3.

FIG. 3 illustrates a process 300 for an intelligent proximity system according to embodiments of the present disclosure. An embodiment of the process illustrated in FIG. 3 is for illustration only. One or more of the components illustrated in FIG. 3 may be implemented in specialized circuitry configured to perform the noted functions or one or more of the components may be implemented by one or more processors executing instructions to perform the noted functions. Other embodiments of a process 300 for an intelligent proximity system could be used without departing from the scope of this disclosure.

In the example of FIG. 3, an intelligent proximity system takes an action request at block 310. At block 320, the intelligent proximity system acquires signal and/or sensor readings. At block 330, the intelligent proximity system identifies proximity (also referred to herein as a zone). Finally, at block 440, the intelligent proximity system triggers actions.

Although FIG. 3 illustrates one example of a process 300 for an intelligent proximity system, various changes may be made to FIG. 3. For example, while shown as a series of steps, various steps in FIG. 3 could overlap, occur in parallel, occur in a different order, or occur any number of times.

In one embodiment, the intelligent proximity system includes several components that enable identifying the user's location (e.g., zone) and an appropriate action. The components may be a combination of hardware and software components. For instance, the user's location may be determined based on interaction between a UE, the user, nearby devices and/or the cloud. For example, hardware components of an intelligent proximity system may include any of a UE device, a control unit (CU), an action target, and wireless connections.

A UE device can be a cellphone, a smartwatch, or any mobile personal device that can collect the desired signal and provide one or more of the functionalities and interact with the user.

A CU may refer to a logical entity. The CU can reside in one entity (either dedicated or shared) or be distributed over multiple entities. The entity could be, for example, a hub, a server in the cloud, or the UE. The CU can perform one or more of the software functionalities described herein.

An Action target can be certain actuators, peripherals, or the UE itself. The action target performs the action of the user. Examples action targets include, but are not limited to light bulbs, refrigerators, air-conditioning systems, and door locks.

In one embodiment, wireless connections enable the UE device to interact or communicate with the cloud, the hub, or other devices in the environment. The wireless connection can be over any means that can be used for wireless communication, such as radio frequency signals and ultrasound. For example, RF communication can be over, e.g., Bluetooth, WiFi, or cellular communication.

Examples of interaction between the above hardware components is shown in FIG. 4.

FIG. 4 illustrates an example 400 of interactions in an intelligent proximity system according to embodiments of the present disclosure. The embodiment of an intelligent proximity system of FIG. 4 is for illustration only. Different embodiments of an intelligent proximity system could be used without departing from the scope of this disclosure.

In the example of FIG. 4, user 410 interacts with various devices 420-450, and devices 420-450 interact with each other. In one embodiment, user 410 interacts directly with UE 420 and/or 430 through associated interfaces. For example, the interface may be an application, a webpage, a voice assistant, etc. In some embodiments, CU 430 may provide most of the software functionality for the intelligent proximity system. In some embodiments, CU 430 can reside either entirely or partially within UE 420. As shown in FIG. 4, wireless systems 440 are connecting several components. However, it should be understood that the devices of an intelligent proximity system may be connected with other communications systems. For example, in one embodiment, CU 430 may be implemented in a hub, and can be connected to actuator devices through a physical network such as wired ethernet. In some embodiments, user 410 may interact with action targets 450 (e.g., actuators and peripheral) directly, or through UE420 and/or CU 430 via wireless systems 440 according to particular needs.

Although FIG. 4 illustrates an example 400 of interactions in an intelligent proximity system, various changes may be made to FIG. 4. For example, various changes to the number of devices, the type of devices, etc. could be made according to particular needs.

In one embodiment, the intelligent proximity system includes software modules. The software modules may encompass interfaces between the UTE and the user, data collection and processing, proximity assessment, and tools to communicate with nearby devices, e.g., over the cloud.

In one embodiment, the intelligent proximity system includes a user interface through which the user can directly or indirectly request certain services. The user interface may allow for active or proactive requests. An example of an active request is a direct voice command or action selection through a visual interface, e.g., to switch the light on where the user is present. A proactive method can be based on, for example, a predefined rule that can be designed or pre-mined rules based on earlier activities. An example of a pre-mined rule is that the user prefers to play certain soothing noises or turn on certain lights when going to bed.

In one embodiment, the intelligent proximity system includes a signal collection and processing module. To identify the user location, the intelligent proximity system uses readings of the signal from wireless systems or sensors. The readings may include received signal strength (RSS), and the received signal (which could be complex values) of one or more of the available wireless systems, e.g., WiFi or Bluetooth. Furthermore, the system may optionally read IMU measurements, possibly the magnetic field and ultrasound signals. The system can save the data for later processing and proximity identification. In one embodiment, the signal collection and processing module may provide any of data collection, data processing, and/or zone tagging functionality. For example, the signal collection and processing module may include a data collection sub-module, a data processing sub-module, and a zone tagging sub-module.

In one embodiment, the data collection sub-module enables the intelligent proximity system to identify the capabilities of the available wireless transceivers (of the UE and possibly the neighbor devices) and the available sensors. In one embodiment, the data collection sub-module also manages and optionally schedules readings from these transceivers and sensors, and data storage.

The signal readings can be noisy or have missing values. Furthermore, the data can be compressed or transformed to proper values, e.g., calculating some statistics. The data processing sub-module may perform these tasks.

To identify the zone for given signal reading a proper inference model should be used. However, to train, select, and/or tune, the model(s) some “true” zone information should be provided. In one embodiment, the zone tagging sub-module uses one or more methods to acquire the zone information.

In one embodiment, the intelligent proximity system includes a module to construct proximity inference models. This module utilizes the collected data and the tags to build a solution that maps observed readings to zones. The model can be machine learning or statistical or geometric models. In one embodiment, the module identifies the proper structure (or trains) of one or more of the predefined models and can run performance assessments of the models.

In one embodiment, the intelligent proximity system includes a proximity inference and assessment module. In one embodiment, when the user requests a service (directly or indirectly), the proximity service runs one or more of the models to infer the user's proximity. In one embodiment, the proximity results are processed, and the result that includes the estimated zone and optionally the confidence level can be forwarded to the user or the CU for further action.

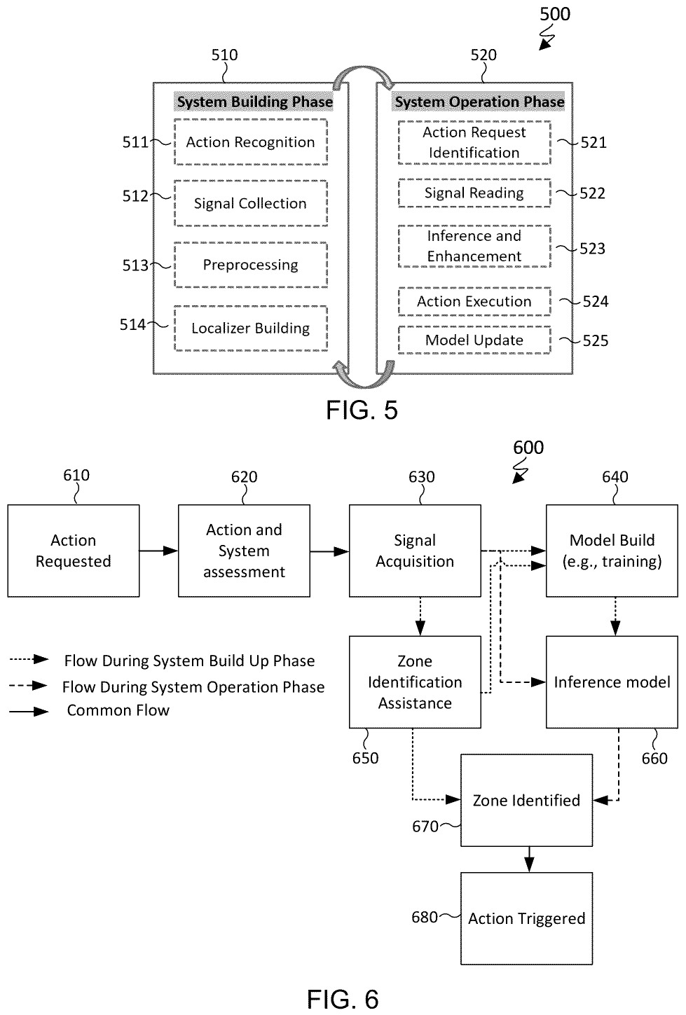

During operation, the intelligent proximity system may operate in two phases as illustrated in FIG. 5.

FIG. 5 illustrates an example 500 of overall operation of an intelligent proximity system according to embodiments of the present disclosure. The embodiment of an intelligent proximity system of FIG. 5 is for illustration only. Different embodiments of an intelligent proximity system could be used without departing from the scope of this disclosure.

In the example of FIG. 5, high-level operations of an example intelligent proximity system. The intelligent proximity system of FIG. 5 operates in two phases 510 and 520. The first phase is system building phase 510. The second phase is system operation phase 520. While phases 510 and 520 are shown as distinct, phases 510 and 520 may also be intertwined during operation of the intelligent proximity system. Furthermore, the intelligent proximity system can apply all or sub-set of the operations of phase 510 and 520.

Phase 510 is a system building phase. Phase 510 includes operations 511-514. Operation 511 is action recognition. Operation 512 is signal collection. Operation 512 is preprocessing. Operation 514 is localizer building.

Phase 520 is a system operation phase. Phase 520 includes operations 521-525. Operation 521 is action request identification. Operation 522 is signal reading. Operation 523 is inference and enhancement. Operation 524 is action execution. Operation 525 is model updating.

Although FIG. 5 illustrates an example 500 of overall operation of an intelligent proximity system, various changes may be made to FIG. 5. For example, various changes to the number of phases, the number of operations, the type of operations, etc. could be made according to particular needs.

FIG. 6 illustrates a method 600 of operating an intelligent proximity system according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a method 600 of operating an intelligent proximity system could be used without departing from the scope of this disclosure.

Method 600 includes phase dependent flows. The flow followed is dependent on whether the system is operating in the system building phase (e.g., phase 510 of FIG. 5) or the system operation phase (e.g., phase 520 of FIG. 5). In the example of FIG. 6, the method begins at block 610. At block 610, the intelligent proximity system receives a request (i.e., an action trigger). When the system receives a request e.g., the user asks to turn on local light, at block 620 an assessment is made whether that action can be fulfilled. An action can generally be classified as location based (referred to herein as “type-1”) or not location-based (referred to herein as “type-2”). Furthermore, location-based actions may be further classified as requiring assistance (referred to herein as “type-la” or no assistance being needed (referred to herein as “type-1b”).

If the received action is of type-2, the user or the CU can be notified that the request is non-location based, and no further actions from the intelligent proximity system are taken. If the received action is of is of type-la (typically during the system build-up phase), then at block 650 the CU or the user is notified for possible zone identification assistance needed to identify the zone or the device. The zone identification assistance may depend on one or more of the following: the capability of the UE, the CU, the available devices in the environment, and the system setup. In one embodiment, the user can be asked to provide assistance information. For example, the user may be prompted to provide the name of the zone, select from a list, or choose the device. When that assistance information is provided, the assistance information can be used for proximity inference construction as well. The assistance information can further be used to trigger the action.

To construct the inference model, at block 630 the UE acquires useful signals based on the capability of the UE and/or the available devices and infrastructure in the environment. The signal, along with the zone information, are then used to construct proximity model(s) at block 640.

If the received action is of is of type1b (typically when inference model(s) are available), at block 630 the UE acquires usable signals and readings, runs the inference models at block 660, and identifies the zone at block 670. At block 680 the UE may then trigger the action.

Although FIG. 6 illustrates one example of a method 600 of operating an intelligent proximity system, various changes may be made to FIG. 6. For example, while shown as a series of steps, various steps in FIG. 6 could overlap, occur in parallel, occur in a different order, or occur any number of times.

In one embodiment, signals and measurement readings are used to identify the zones in the operation phase. In one embodiment, appropriate signal and zone information are used to build the inference model. The acquisition of the signals can be during user initialization, or the signals can be collected as needed.

In user initialization based acquisition, the user is requested to identify the zones. For example, a dedicated interface may prompt the user for the zone identities. In one embodiment, in each zone, using the signal from nearby wireless systems, local sensor measurements are collected for T_{Collect2Construct}. In one embodiment, the collection time can be as long as the UE is within the given zone.

In one embodiment, for T_{Collect2Construct}, the system provides or utilizes signal variations for a given zone. That is, the system can collect a log for the signal variations. The definition of variation, can be based on the similarity metric, e.g., correlation metric:

$${ρ}_{t} = \frac{\vert {S}_{t - 1} {S}_{t} \vert}{\sqrt{\vert {S}_{t - 1} \vert \vert {S}_{t} \vert}} ,$$

where Sₜ is the signal collected at time t. Then the system can collect S until the correlation value, for instance, stays above a certain threshold, e.g., 0.9, for T_corr period, i.e.,

$$\frac{1}{{T}_{corr}} {\sum }_{i = t - {T}_{corr} + 1}^{t} {ρ}_{i} > 0.9 .$$

In one embodiment, the signal is collected as long as it is not significantly correlated with earlier measurements. An alternative metric could be the mutual information or other similarity metrics.

In one embodiment, T_{Collect2Construct} is upper limited by a maximum time T_{Max_Collect}−T_{Max_Collect} can be based on factors such as power consumption, buffer size, or other priory set values.

In a collection as needed based acquisition scheme, the system collects signals when a new request arrives. For example, if the zone cannot be identified, the system can collect the signals similarly as described herein. The collection time can be also based on readings of IMU sensors or other modules that can provide step count or mobility estimation. If the zone cannot be identified through one of the tagging techniques discussed later herein, the user can be prompted for limited data collection.

In one embodiment, T_{Collect2Construct} can be derived based on the typical environment in the region, or a preloaded floor map and knowledge of the mobility speed.

In one embodiment, a localizer module takes some observed data (possibly after preprocessing) to infer the proximity information (the zone), which can be the final output of the system or an intermediate step before triggering the appropriate action. In either case, the zone information is environment dependent, and the system should acquire that information to build (or tune) the inference model and trigger the right actions. In one embodiment, to acquire the zone information, the system may use on one or more of user assistance, nearby devices, wireless signal propagation properties, sensors, mined patters, or signal-post processing as discussed herein.

In one embodiment, the system may use user assistance to acquire zone information. For example, the user may explicitly provide the zones during an active signal collection. The user may provide high-level zone information, possibly by uploading a map or identifying the virtual rooms/regions of the environment or their numbers. In one embodiment, when a new request is identified. The user can be triggered to identify the zone, e.g., from a pre-defined list, or explicitly provided by the user.

In one embodiment, the system may utilize nearby devices to acquire zone information. For example, to tag the collected signal, the system can use ultrasound communication, e.g., between the UE and a nearby TV. In one embodiment, the UE can emit the ultrasound signal, and nearby devices can detect it. The devices that can detect the ultrasound signal can be assumed to be within the same zone as the UE. The CU can coordinate ultrasound transmission and detection.

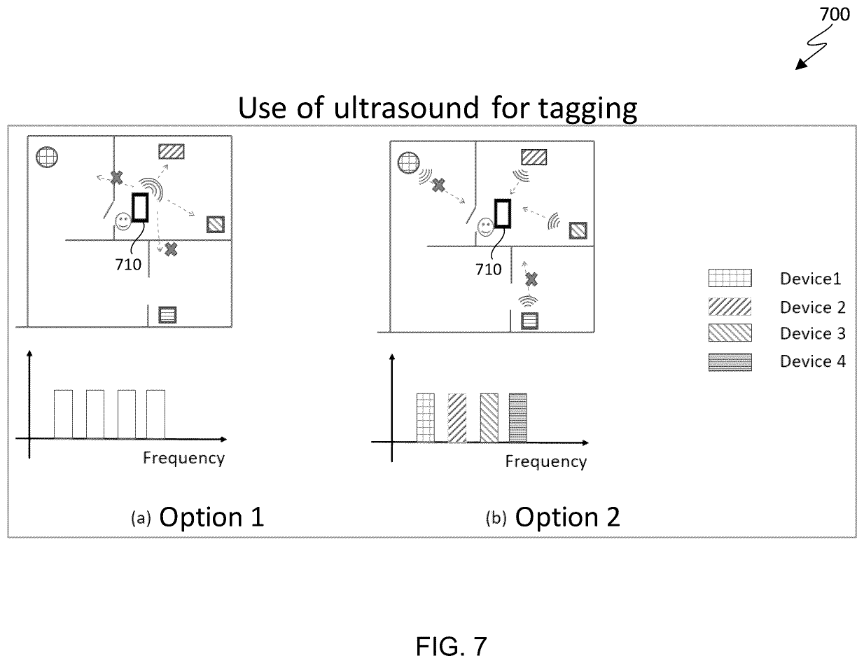

In one embodiment, devices can emit ultrasound signals. The device for which the UE detects its signal can be assumed to belong to the same zone. To limit interference, the CU can assign signal orthogonality, e.g., using different pseudo-noise sequences or using Orthogonal Frequency Division Multiple Access (OFDMA) like access. To differentiate between the devices, in one embodiment, the sequences and/or tones allocation patterns may be used to identify the nearby device as illustrated in FIG. 7.

FIG. 7 illustrates an example 700 of using ultrasound for zone identification according to embodiments of the present disclosure. The embodiments using ultrasound for zone identification system of FIG. 7 are for illustration only. Different embodiments of using ultrasound for zone identification could be used without departing from the scope of this disclosure.

In the example of FIG. 7, two scenarios are shown. In scenario (a), a UE 710 emits an ultrasound signal. In scenario (b), devices 1, 2, 3, and 4 emit ultrasound signals, each device emitting different tones, similar to an OFDMA technique. In both scenario (a) and (b), UE 710 is in the same zone as device 2 and device 3.

Although FIG. 7 illustrates an example 700 of using ultrasound for zone identification, various changes may be made to FIG. 7. For example, various changes to the number of devices, the type of devices, etc. could be made according to particular needs.

In one embodiment, the different devices can be scheduled by a CU Time Division Duplexing based transmission. In one embodiment, the transmitted signal can encode device ID. The device ID can be either pre-set or assigned by the CU.

In one embodiment, the system may use wireless signal propagation properties to acquire zone information. For example, the system may utilize prior knowledge to identify the proximity to wireless emitters (e.g., WiFi access points) where the maximum transmission power can be known, and the carrier frequency range is known. Then a received power close to Free Space Path Loss (FSPL) can be assumed to be Line of Sight (LOS). A prior distance threshold or power threshold can be set to assume the proximity to the AP in this case. The system can also use a threshold on the received signal strength. In one embodiment, the time of arrival can be used to estimate the distance.

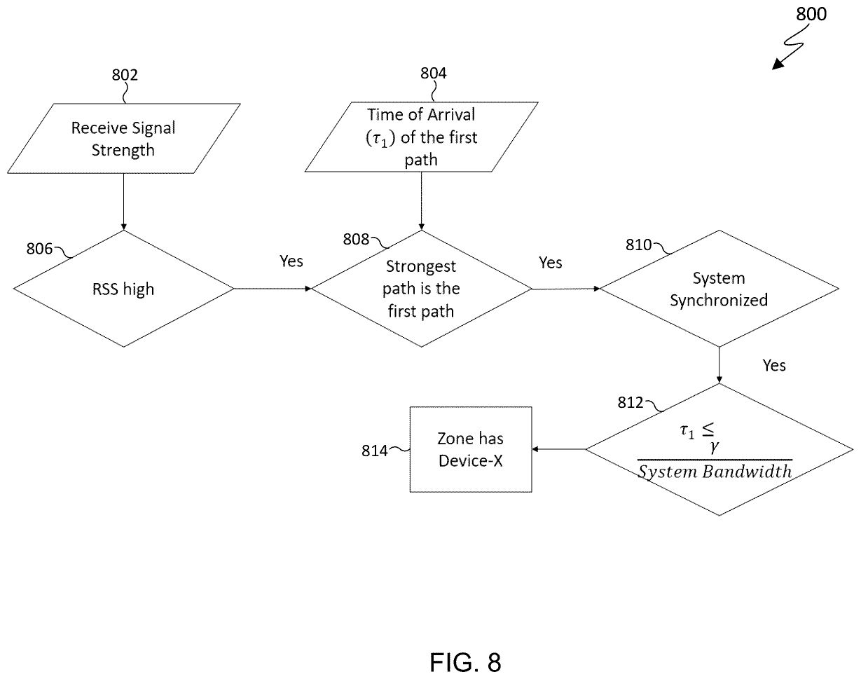

FIG. 8 illustrates a method 800 of using Line of Sight in wireless communication to identify zones according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of a method 800 of using Line of Sight in wireless communication to identify zones could be used without departing from the scope of this disclosure.

In the example of FIG. 8, a UE considers both the time of arrival (804) and the signal strength (802) of a nearby AP. At step 806, the UE determines the received power or the estimated distance of the AP. At step 808, the UE measures the time of arrival of the AP. At step 810, the result of steps 806 and 808 can be combined to identify the LOS path. At step 812, the last test in FIG. 8 has parameter y that is based on the system bandwidth. Systems with large bandwidths can have high time (and distance) resolution. For example, with ultrawide band links, time resolution can be within a few centimeters, thus y can be chosen for, e.g., devices with 3 m bandwidth. Note that weak received power or delayed LOS (due to internal errors) are possible. Thus, this solution may not guarantee the detection of a nearby AP. If after step 812 the UE determines that the condition is true, at step 814 the UE determines that the nearby AP (e.g., “Device-X” is in the same zone as the UE).

Although FIG. 8 illustrates one example of a method 800 of using Line of Sight in wireless communication to identify zones, various changes may be made to FIG. 8. For example, while shown as a series of steps, various steps in FIG. 8 could overlap, occur in parallel, occur in a different order, or occur any number of times.

In one embodiment, the system may use available sensors or mined patterns to acquire zone information. For example, the CU can help in proximity detection based on pattern mining or preinstalled proximity sensors, e.g., motion sensors.

In one embodiment, the system may use signal post-processing with unsupervised learning approaches to acquire zone information. For example, the system can use methods like dimensionality reduction, or clustering along with dead-reckoning or trajectory learning to learn the structure of the environment. The final structure may use prior information by the user, such as maps or number of (possibly virtual) rooms.

Note that the system may use one or more of the above described solutions to tag the collected zones information. A post-processing step can be applied to combine the zones. In one embodiment, if the several devices (e.g., from ultrasound and wireless signals) were detected when performing signal collection in the same zone, then the devices can be assumed to belong to one zone. In one embodiment, a clustering of the signal can identify whether two devices might belong to the same zone.

The inference model is an important component of the system. There are variety of methods that can be used for proximity estimation.

In one embodiment, when a dataset of signals and tags are provided, e.g., after system setup, the system uses them to train an Al model. The model could be an instant based model, e.g., K-Nearest Neighbors, or other models such as random forest or neural network based. In one embodiment, the system can build a single model that produces the zone number. The prediction confidence can be either an output of the model or can be estimated. For instance, a random forest can use counting of a number of instances per branch to estimate the confidence of the prediction.

In one embodiment, one model per zone can be constructed. This approach can be used with a gradual system data collection mechanism, for example, when only few zones have been visited. The maximum number of zones can be estimated based on explicit user input, or within a few days of system installation if the user selected opt out of full system setup.

In one embodiment, when the LOS to an AP or nearby devices are available, or CU assistance (through, e.g., communication with external sensors) is available, the proximity in that zone can use special rules for proximity detection for that zone.

In one embodiment, multiple models can be constructed, using different feature sets, or Al models, or one more of the above. The selection of the model can be done online based on the performance of the models. Alternatively, a combing technique can be used, e.g., by averaging the prediction of all models, or using majority votes, or weighted average. The weights can be based on the performance. For instance, let Bₘ be the prediction of model m that represents a vector of size Z, which represents the probability of each one of the Z zones is true. The prediction of model mϵ1, . . . , M (out of M models), where B of size Z, Z is the number of zones. The final prediction can be

$$B = \frac{1}{M} {\sum }_{m}^{M} {w}_{m} {B}_{m}$$

where wₘ is the weight of model m.
An example of a method to define the weight is to let

$${\tilde{w}}_{m} = \frac{number of times model m was correct}{Total number of timez the model was called}$$

### Then

$${w}_{m} = \frac{{\tilde{w}}_{m}}{{\sum }_{m} {\tilde{w}}_{m}} .$$

The input to the models may depend on the implemented options and used signals. For example, the input can, include, the raw or processed signals, e.g., the Received Signal Strength (RSS) vectors from all or a subset of the AP or Bluetooth devices.

The preprocessing steps may include, outlier elimination, missing values replacement, feature engineering, and transformation.

In one embodiment, preprocessing includes outlier elimination. For example, if a received signal is empty or above or below a threshold, the signal may be removed from further processing.

In one embodiment, preprocessing includes missing values replacement. For example, missing values can be set to a minimum detectable signal level, or replaced by unique numbers. In another example using sample and hold to the nearest correctly detected signal within T_{hold}, i.e., let S_{t,j} be the signal from an AP j at time t. Then S_{t+τ,j}=S_{t,j} if t−τ<T_{hold} and S_{t,j} is considered reasonable, i.e., not an outlier or missing. T_{hold} can be set, for instance, as a fraction of T_{Max_Collect}. The fraction may depend on factors such as an inference window, UE speed or system limitations.

In one embodiment, preprocessing includes feature engineering. For example, features that include the statistics from a given AP or in a given zone can be used. Such features may include, for example:
The difference to minimum and/or maximum of priory recorded RSS for the given AP.
The variance of received signal.
Differential or normalized values to anchor values, e.g., Ŝ_{t,j}=Sₜⱼ−S_{ti*}, where S_{ti*} is the signal received from an AP i*. The AP i*could be selected based on the availability in all zones.

In one embodiment, preprocessing includes transformation. For example, the signal level or delay of strongest path of the signal can be identified in the “delay domain” by using a Fast Fourier Transform.

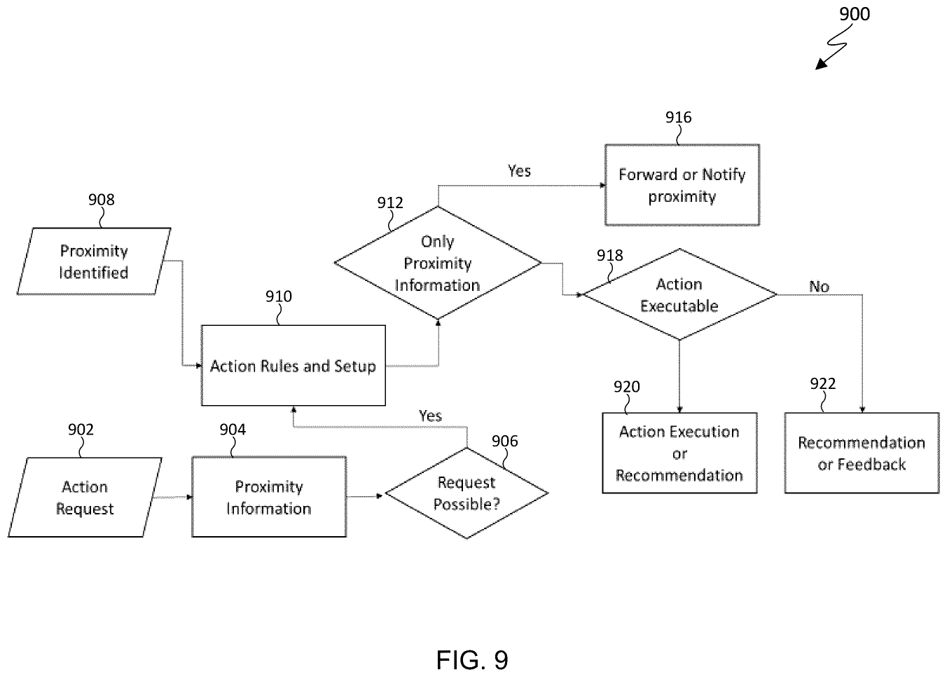

In one embodiment, the intelligent proximity system can be used to initialize actions based on active or proactive user requests. For example, there are several types of actions the system may take based on a request, and the system may allow all or sub-set of them. FIG. 9 shows a method of action triggering.

FIG. 9 illustrates a method 900 of action triggering according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of a method 900 of action triggering could be used without departing from the scope of this disclosure.

In the example of FIG. 9, the intelligent proximity system receives an action request 902. At step 904, the system evaluates current proximity information. At step 906, the system determines whether the request is possible. If the request is possible, at step 910 the system takes the action request 902 and the proximity identified 908 and triggers the action based on action rules and setup. Depending on the system setup, the output can be (i) the proximity information only (step 912) that can be forwarded to the CU (which can be used in other application) or conveyed to the user (step 916), or (ii) to execute initialize or recommend certain actions based on the proximity information (step 920). The system may be setup to produce both (i and ii) (to convey the proximity information and initialize certain action). At step 922, the system performs a recommendation operation or a feedback operation if the action was not executable.

As previously discussed herein, in one embodiment, the system may be configured to produce proximity information only. This could include proximity information with or without confidence level. Producing the proximity information can be based on user request, CU request, or proactively as proximity notifications.

As previously discussed herein, in one embodiment, the system may be configured to activate actions. Activating actions may include performing procedures such as requests filtering, action recommendations, action fulfillment, and action triggering.

In one embodiment, requests filtering may occur because sometimes the action request cannot be satisfied. This can occur if a user request is not location based, the system is not initialized, or the proximity confidence level is small.

In one embodiment, action recommendations may be based on proactive requests. For example, the system can trigger an action recommendation based on proximity information, e.g., drink water while in the close to water cooler.

In one embodiment, if the user gives consent for action fulfilment, the system can activate the action based on proximity information. For example, the system may implement an action sensitivity filter that prevents action fulfilment if the action has safety aspects to it, e.g., turn stove on. These actions can be filtered according to confidence level. For example, the front door may only be opened when the confidence level for the proximity is high.

Although FIG. 9 illustrates one example of a method 900 of action triggering, various changes may be made to FIG. 9. For example, while shown as a series of steps, various steps in FIG. 9 could overlap, occur in parallel, occur in a different order, or occur any number of times.

To execute or trigger an action on an actuator, or a device in general, the system should know the zone of that device. For example, to acquire this information, the system can rely on one or more of explicit mapping, direct communication, or pattern mapping.

In one embodiment, to acquire the zone of a device, the system uses explicit mapping. For example, during initialization, the user can explicitly assign the available devices to zones, or devices could be plugged in to terminals with known zones. In another embodiment, the user could explicitly teach system association between the device and the zone at initial request. For instance, the user can request a light on and manually switch a light on in that zone.

In one embodiment, to acquire the zone of a device, the system uses direct communication. For example, some devices may be equipped with communication tools, such as direct WiFi, Bluetooth or ultrasound. The system can utilize one or more of these links to associate devices to zones.

In one embodiment, to acquire the zone of a device, the system uses pattern mapping. For example, the devices could be identified by association. If a usage of a device is highly correlated with a device in known zone, the system can associate the two. For instance, an initial light change request can be correlated with TV usage. If the TV is in a known zone the light may belong to the same zone.

The requests that the system might fulfill could be actions that are actively or proactively selected. Initially, the user may be provided with a list of possible actions that the CU might detect or sub-select. For example, the possibility of light switching, AC control, dishwasher control etc., may be provided to the user. In one embodiment, the user can select implicitly or explicitly the actions (along possibly with the action sensitivity level) for execution by the intelligent proximity system. For example, the user may not allow door lock control, but allow lights control.

In one embodiment, the CU may also mine patterns of actions that can be mapped to proximity information. For example, the user preparing tea in the morning when entering a kitchen. In another example, the system can switch on water a kettle or send a user notification for that action if detected. A simplified rule mining solution is disclosed below with respect to the information in Table 1.

TABLE 1

| Time | Proximity/Zone | Confidence | Devices |
|---|---|---|---|
| May 21, 2023 - 8:22 | Zone A | 0.91 | Light X switched ON |
| May 21, 2023 - 8:23 | Zone A | 0.92 | TV-2 switched ON |
| . | . | | . |
| . | . | | . |
| May 22, 2023 - 8:16 | Zone A | 0.89 | Light X switched ON |
| May 22, 2023 - 8:18 | Zone A | 0.9 | TV-2 switched ON |

For example, the system (the CU) can associate Zone-A at time 8:10-8:30 (for example) with switching on light X and TV-2. The rules can be later suggested to the user for sub-selection and filtering. When a new rule or action is detected, with a reasonable proximity confidence, the user can be given the option to enable it or discard it.

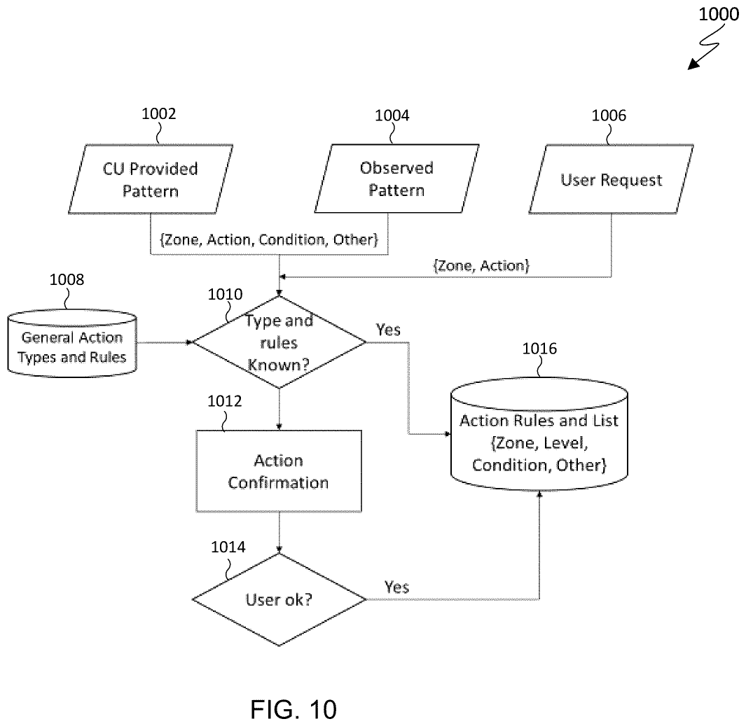

FIG. 10 shows an implementation of adding an action to the action list along with the appropriate rules.

FIG. 10 illustrates a method 1000 for action rules and list construction according to embodiments of the present disclosure. An embodiment of the method illustrated in FIG. 10 is for illustration only. One or more of the components illustrated in FIG. 10 may be implemented in specialized circuitry configured to perform the noted functions or one or more of the components may be implemented by one or more processors executing instructions to perform the noted functions. Other embodiments of a method 1000 for action rules and list construction could be used without departing from the scope of this disclosure.

In the example of FIG. 10, a new action may be detected in a zone. For example, the CU may provide a pattern (1002), a pattern may be observed (1004), or the user may provide a request (1006) related to an action. At step 1010, a determination is made if the action type is known and if any rules are associated with that action e.g., by checking dataset 1008.

At step 1010, once a new action is detected in a zone (does not belong to the known actions and has no prior rules), the action can be added to the action list and rules database (1016) after user confirmation (step 1012). Otherwise, if the action is known, e.g., switching light bulb, then user confirmation can be skipped. In that case, the user may be notified of adding the action. Depending on whether the action sensitivity is high, the action can be added to the database when user confirms the notification (step 1014).

Although FIG. 10 illustrates one example of a method 1000 for action rules and list construction, various changes may be made to FIG. 10. For example, while shown as a series of steps, various steps in FIG. 10 could overlap, occur in parallel, occur in a different order, or occur any number of times.

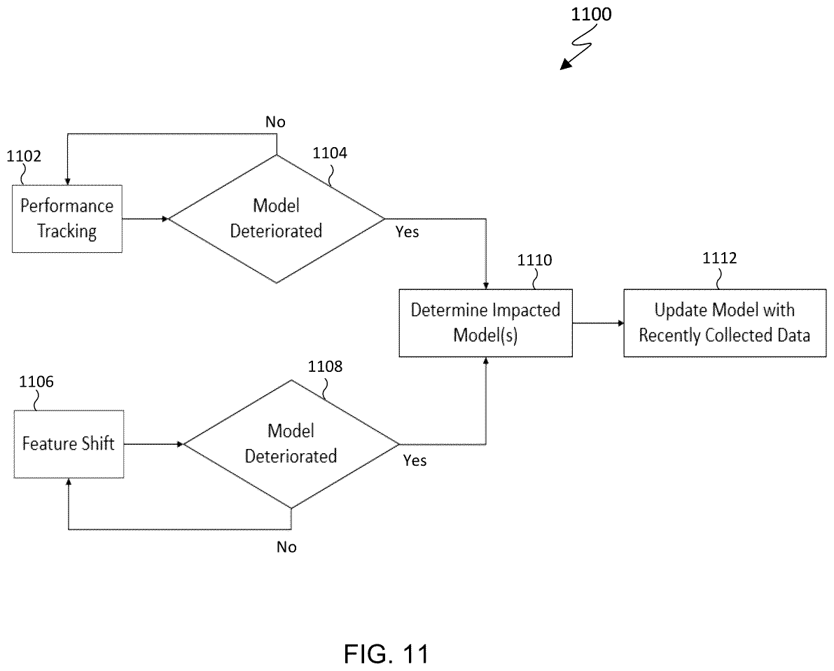

It is expected that while the intelligent proximity system is in use, that the environment will evolve over time. For example, the environment may change due to furniture changes, or new construction. Similarly, infrastructure changes may occur due to installation of new devices, failure of devices, etc. These changes can impact the accuracy of the proximity inference model. Thus, it is desirable to monitor closely the changes in the environment and/or the performance of the intelligent proximity system. FIG. 11 shows an example process for monitoring changes in the environment and updating the proximity inference model in response to the changes.

FIG. 11 illustrates a method 1100 for updating an inference model according to embodiments of the present disclosure. An embodiment of the method illustrated in FIG. 11 is for illustration only. One or more of the components illustrated in FIG. 11 may be implemented in specialized circuitry configured to perform the noted functions or one or more of the components may be implemented by one or more processors executing instructions to perform the noted functions. Other embodiments of a method 1100 for updating an inference model could be used without departing from the scope of this disclosure.

In the example of FIG. 10, the process begins when a change is detected, e.g., at step 1102 or 1106. After a change is detected, the performance of the system is considered in steps 1104 and/or 1108. The system then determines the impacted models at step 1110 and triggers model updates at step 1112.

One metric that the system may use to identify that a change has happened is the inference accuracy. For example, the changes may be utilized if they impact the accuracy of the proximity solution.

In one embodiment, if the model provides a confidence level for a zone prediction, the system can monitor the confidence of the zone predictions, e.g., at step 1102. One way to monitor the confidence of the zone predictions is by using a running average of the zone predictions. For instance, let pᵢ(t) be the confidence level when zone i is predicted at time t. Then the long-term zone i confidence at t given by

$${P}_{i} ( t ) = ( 1 - α ) {p}_{i} ( t ) + α P ( t - {T}_{0} )$$

Where αϵ[0,1] is a design parameter. In one embodiment, pᵢ(t) may be the average prediction of T₀ seconds that may represent the presence window, i.e., the time the user is present in a given zone, which can be derived, for example, based on IMU readings, initial zone consistency period, the user mobility speed, or as a design parameter.

In one embodiment, to measure the accuracy level, the system can observe major variations in certain features e.g., at step 1106. For instance, one or more APs may be missing from the features. For this embodiment, nominal values for a sub-set (or all) of the used features can be tracked. The values could include information such as the statistics of the features, and their limits. This can be implemented per zone or per feature source, e.g., the access point, or in the overall house. The exact implementation will depend on the available computation complexity and the available storage.

When the performance of the system deteriorates, this is correlated with an incorrect triggering of actions. In one embodiment, when the actions are filtered based on sensitivity, the system can rely on the user to identify accuracy deterioration. For example, the system might notify the user of the intended action, e.g., by explicitly stating what the action and where it will take place. The user might cancel the action. This is useful, especially when the confidence level is low. In another embodiment, the user may manually correct the action.

Once a change happens, the system can start to schedule model update phase. In one embodiment, in case of multiple models, the system updates only models related to the impacted zone(s) and or related to the impacted features. For example, if the model deterioration is observed with WiFi signals, then the model that uses WiFi signals only can be updated or down selected based on a weight metric.

In one embodiment, the model update procedure follows the data collection procedure and model construction. For the model update, techniques from online learning can be applied.

Although FIG. 11 illustrates one example of a method 1100 for updating an inference model, various changes may be made to FIG. 11. For example, while shown as a series of steps, various steps in FIG. 11 could overlap, occur in parallel, occur in a different order, or occur any number of times.

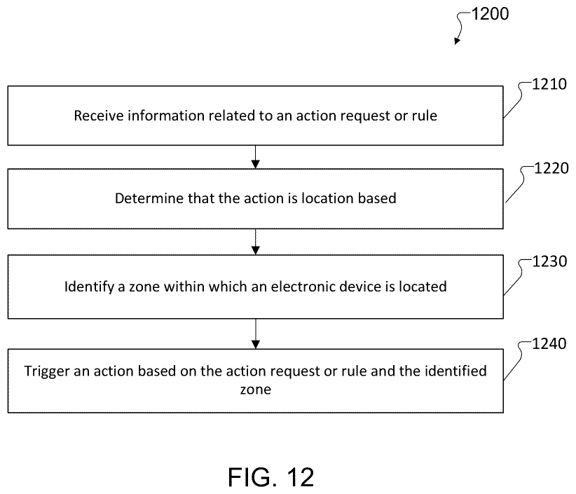

FIG. 12 illustrates a method 1200 for operating an intelligent proximity system according to embodiments of the present disclosure. An embodiment of the method illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments of a method 1200 for operating an intelligent proximity system could be used without departing from the scope of this disclosure.

In the example of FIG. 12, method 1200 begins at step 1210. At step 1210, an electronic device receives information related to an action request or rule. At step 1220, the electronic devices determines that the action is location based. At step 1230, the electronic device identifies a zone within which the electronic device is located. The identification of the zone may be based on at least one of a first reception of at least one signal indicative of a location of the electronic device, and a second reception of at least one response to a transmission of a signal indicative of a location of the electronic device. Finally, at step 1240, the electronic device triggers an action based on the action request or rule and the identified zone.

Although FIG. 12 illustrates one example of a method 1200 for operating an intelligent proximity system, various changes may be made to FIG. 12. For example, while shown as a series of steps, various steps in FIG. 12 could overlap, occur in parallel, occur in a different order, or occur any number of times.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. An electronic device comprising:
a transceiver configured to receive information related to an action request or rule; and
a processor operatively coupled to the transceiver, the processor configured to:
determine that the action is location based;
identify a zone within which the electronic device is located, wherein the identification is based on at least one of:
a first reception by the transceiver of at least one signal indicative of a location of the electronic device; and
a second reception by the transceiver of at least one response to a transmission of a signal indicative of a location of the electronic device; and
trigger an action based on the action request or rule and the identified zone.

2. The electronic device of claim 1, wherein to identify the zone, the processor is further configured to:
determine, based on at least one of the first reception and the second reception, that assistance is needed;
generate a request, based on the determination that assistance is needed, for zone identification assistance from at least one of:
a control unit; and
a user of the electronic device;
receive, via the transceiver, assistance information corresponding to the request, wherein the zone is identified based on the assistance information; and
update a proximity inference model based on the assistance information.

3. The electronic device of claim 1, wherein to identify the zone, the processor is further configured to:
evaluate, based on a proximity inference model, at least one of the first reception and the second reception; and
identify the zone based on a result of the evaluation.

4. The electronic device of claim 1, wherein a signal indicative of the location of the electronic device is one of:
an ultrasound signal; and
a radio frequency (RF) signal.

5. The electronic device of claim 1, wherein the processor is further configured to:
identify a performance metric corresponding with the identification of the zone;
determine, based on the performance metric, that performance of a proximity inference model has deteriorated; and
update the deteriorated proximity inference model with data associated with at least one of the first reception or the second reception.

6. The electronic device of claim 1, wherein to trigger the action, the processor is further configured to:
determine whether the action is executable;
if the action is executable, initiate execution of the action; and
if the action is not executable, initiate a recommendation operation or a feedback operation.

7. The electronic device of claim 6, wherein to determine whether the action is executable, the processor is further configured to:
evaluate, based on an action list and rules database, the action request and the identified zone,
wherein the determination whether the action is executable is based on a result of the evaluation.

8. A method of operating an electronic device, the method comprising:
receiving information related to an action request or rule;
determining that the action is location based;
identifying a zone within which the electronic device is located, wherein the identification is based on at least one of:
a first reception of at least one signal indicative of a location of the electronic device; and
a second reception of at least one response to a transmission of a signal indicative of a location of the electronic device; and
triggering an action based on the action request or rule and the identified zone.

9. The method of claim 8, wherein identifying the zone comprises:
determining, based on at least one of the first reception and the second reception, that assistance is needed;
generating a request, based on the determination that assistance is needed, for zone identification assistance from at least one of:
a control unit; and
a user of the electronic device;
receiving assistance information corresponding to the request, wherein the zone is identified based on the assistance information; and
updating a proximity inference model based on the assistance information.

10. The method of claim 8, wherein identifying the zone comprises:
evaluating, based on a proximity inference model, at least one of the first reception and the second reception; and
identifying the zone based on a result of the evaluation.

11. The method of claim 8, wherein a signal indicative of the location of the electronic device is one of:
an ultrasound signal; and
a radio frequency (RF) signal.

12. The method of claim 8, further comprising:
identifying a performance metric corresponding with the identification of the zone;
determining, based on the performance metric, that performance of a proximity inference model has deteriorated; and
updating the deteriorated proximity inference model with data associated with at least one of the first reception or the second reception.

13. The method of claim 8, wherein triggering the action comprises:
determining whether the action is executable;
if the action is executable, initiating execution of the action; and
if the action is not executable, initiating a recommendation operation or a feedback operation.

14. The method of claim 13, wherein determining whether the action is executable comprises evaluating, based on an action list and rules database, the action request and the identified zone, wherein the determination whether the action is executable is based on a result of the evaluation.

15. A non-transitory computer readable medium embodying a computer program, the computer program comprising program code that, when executed by a processor of a device, causes the device to:
receive information related to an action request or rule;
determine that the action is location based;
identify a zone within which the device is located, wherein the identification is based on at least one of:
a first reception of at least one signal indicative of a location of the device; and
a second reception of at least one response to a transmission of a signal indicative of a location of the device; and
trigger an action based on the action request or rule and the identified zone.

16. The non-transitory computer readable medium of claim 15, wherein to identify the zone, the computer program further comprises program code that, when executed by the processor, causes the device to:
determine, based on at least one of the first reception and the second reception, that assistance is needed;
generate a request, based on the determination that assistance is needed, for zone identification assistance from at least one of:
a control unit; and
a user of the device;
receive assistance information corresponding to the request, wherein the zone is identified based on the assistance information; and
update a proximity inference model based on the assistance information.

17. The non-transitory computer readable medium of claim 15, wherein to identify the zone, the computer program further comprises program code that, when executed by the processor, causes the device to:
evaluate, based on a proximity inference model, at least one of the first reception and the second reception; and
identify the zone based on a result of the evaluation.

18. The non-transitory computer readable medium of claim 15, wherein a signal indicative of the location of the device is one of:
an ultrasound signal; and
a radio frequency (RF) signal.

19. The non-transitory computer readable medium of claim 15, wherein the computer program further comprises program code that, when executed by the processor, causes the device to:
identify a performance metric corresponding with the identification of the zone;
determine, based on the performance metric, that performance of a proximity inference model has deteriorated; and
update the deteriorated proximity inference model with data associated with at least one of the first reception or the second reception.

20. The non-transitory computer readable medium of claim 15, wherein to trigger the action, the computer program further comprises program code that, when executed by the processor, causes the device to:
determine whether the action is executable;
if the action is executable, initiate execution of the action; and
if the action is not executable, initiate a recommendation operation or a feedback operation.
